(19) United States
(12) Patent Application Publication
(10) Pub. No.: US 2026/0306348 A1
(43) Pub. Date: Oct. 8, 2026

(54) Sexual Stimulation Toy and Speaker

(71) Applicant: SISU IP Holding LLC, LANTANA, FL (US)

(72) Inventor: Mya L Johnson, Lantana, FL (US)

(73) Assignee: SISU IP Holding LLC, LANTANA, FL (US)

(21) Appl. No.: 19/413,081

(22) Filed: Dec. 9, 2025

Related U.S. Application Data
(60) Provisional application No. 63/730,547, filed on Dec. 11, 2024.

(51) Int. Cl. A61H 19/00; A61H 23/02

(52) U.S. Cl. CPC A61H 19/44; A61H 23/02; A61H 2201/0207; A61H 2201/5012; A61H 2201/5048; A61H 2201/5097

(57) ABSTRACT

A system for providing a wireless-enabled sex toy having an internal cavity divided into a upper compartment and a bottom compartment having a sex toy elongated body and an inner cavity. The inner cavity encloses a wireless transmitter-receiver, a heating element, a vibration generator, a microphone, a speaker, and an electronic controller circuitry. The electronic controller circuity includes an audio circuitry, a charging circuit, a rechargeable battery, a wireless modem, a data storage device, and a controller.

### RELATED APPLICATIONS

The instant patent application is related to a concurrently owned and filed U.S. Provisional Patent Application, entitled “AI-Based Wireless-Enabled Sex Toy Board Game,” Serial Number, 63/693,795. filed on 19 Sep. 2024, Attorney Docket No. GIPL1051.001-US-01, U.S. Provisional Patent Application, entitled “AI-Based Wireless-Enabled Sex Toy Board Game,” Serial Number, 63/693,802. filed on 19 Sep. 2024, Attorney Docket No. GIPL1051.001-US-03, U.S. Provisional Patent Application, entitled “AI-Based Wireless-Enabled Sex Doll,” Serial Number, 63/693,800. filed on 19 Sep. 2024 Attorney Docket No. GIPL1051.001-US-02, U.S. Provisional Patent Application, entitled “Self-Lubricating Sex Toy,” Serial Number, ??/???,???. filed on ?? Dec. 2024 Attorney Docket No. GIPL1051.001-US-05 and U.S. Provisional Patent Application, entitled “Sexual Stimulation Toy Having Lights, Motion, and Sound,” Serial Number, ??/???,???. filed on ?? Dec. 2024 Attorney Docket No. GIPL1051.001-US-06. These applications are incorporated herein as if they are recited in their entirety.

### TECHNICAL FIELD

This application relates in general to a system and method for providing a sexual stimulation toy, and more specifically, to a system and method for providing a sex toy having an integrated speaker coupled to the surface of the device.

### BACKGROUND

Sex toys are a large business market used by individuals and couples as part of intimate sexual activity. Individuals and couples utilize these sex toys when together or located in different locations. These individuals may desire to hear music, sound effects, and mood ambience sounds to increase the pleasure from the use of the sex toys. When the couples are apart, they may communicate using wireless devices such as smartphones, computing devices, tablets, and the like over a Voice-over-IP connection. This communications is to be heard by an individual using the sex toy which may not be readily possible by the proximity of the wireless device to the individuals.

Therefore, a need exists for a wireless-enabled sex toy having an integrates speaker, so individuals and couples can receive relevant responses sounds such as music, sound effects, and voice communications without a significant interruption to their activity. .

### SUMMARY

In accordance with the present invention, the above and other problems are solved by providing a system and method for providing a sex toy having an integrated speaker coupled to the surface of the device according to the principles and example embodiments disclosed herein.

In one embodiment, the present invention is a system for providing a sex toy having an integrated speaker coupled to the surface of the device. The integrated speaker may generate sounds of music, sound effects, mood ambiance, and voice signals.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for external components of an article of manufacture for providing a sex toy having an integrated speaker coupled to the surface of the device according to the present invention.

FIGS. 2a-b illustrate additional example embodiments of an article of manufacture for providing a sex toy having an integrated speaker coupled to the surface of the device according to the present invention.

FIGS. 3a-f illustrate a plurality of speaker placement arrangements for providing a sex toy having an integrated speaker coupled to the surface of the device according to the present invention.

FIG. 4 illustrates a generalized schematic of a programmable processing system utilized as the various computing components described herein used to implement an embodiment of the present invention.

FIG. 5 illustrates a set of software components executable in a programable computing device for providing a sex toy having an integrated speaker coupled to the surface of the device according to the present invention.

### DETAILED DESCRIPTION

This application relates in general a system and method for sex toy providing sexual stimulation, and more specifically, to a providing a sex toy having an integrated speaker coupled to the surface of the device according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps or components. It also should be noted that in some alternative implementations, the functions and acts noted may occur out of the order noted in the figures. For example, two figures shown in succession may be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a media player, set-top box, smartphone, tablet, and/or web browser on any computing device.

The terms “partners,” “individuals,” and “user” refer to an entity, e.g. a human, using a wireless-enabled sex toy including any software or smart device application(s) associated with the invention. The terms user, partner, and individual herein refer to one or more humans.

The term “connection” refers to connecting any component as defined below by any means, including but not limited to, a wired connection(s) using any type of wire or cable for example, including but not limited to, coaxial cable(s), fiber optic cable(s), ethernet cable(s) or wireless connection(s) using any type of frequency/frequencies or radio wave(s). Some examples are included below in this application.

The term “invention” or “present invention” refers to the invention being applied for via the patent application with the title “Wireless-Enabled Sex Toy.” Invention may be used interchangeably with sex toy.

The term “sex toy” refers to an electronic sexual stimulation device for use by individuals and partners while engaging in sexual activity, including obtaining assistance and advice, suggestions, and gameplay.

The terms “communicate”, or “communication” refer to any component(s) connecting with any other component(s) in any combination for the purpose of the connected components to communicate and/or transfer data to and from any components and/or control any settings.

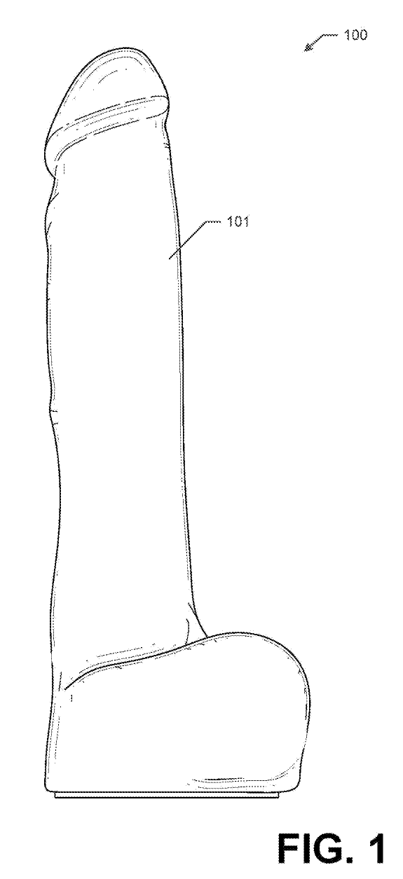

In general, the present disclosure relates a system and method for providing wireless-enabled sex toy according to the present invention. To better understand the present invention, FIG. 1 illustrates an example embodiment for external components of an article of manufacture for providing a sex toy having an integrated speaker 104 coupled to a bottom surface of the device in which an audio internal speaker elements 104 coupled to an inner surface of the device. The wireless-enabled sex toy elongated body 101 includes an inner cavity of the wireless-enabled sex toy elongated body 101 for storing an electronic controller circuitry 202 and related components.

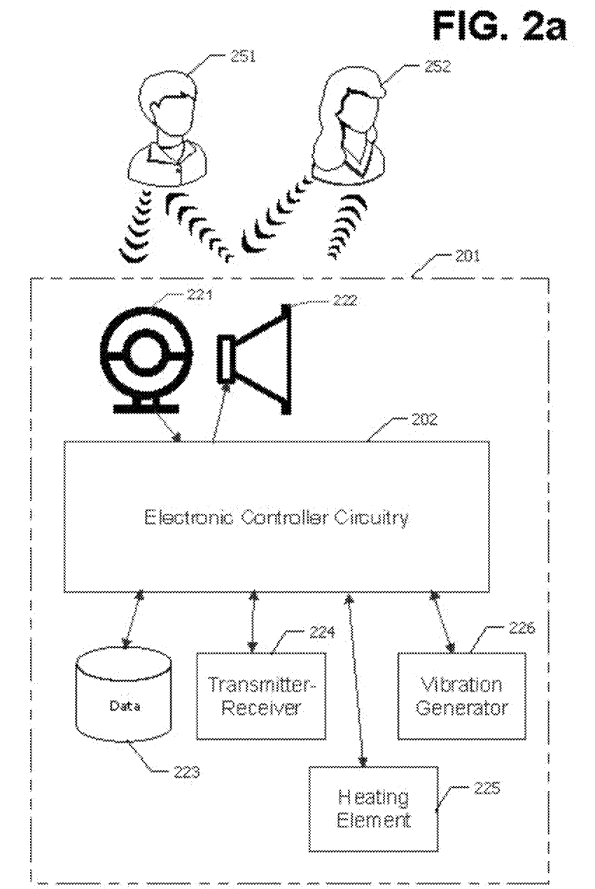

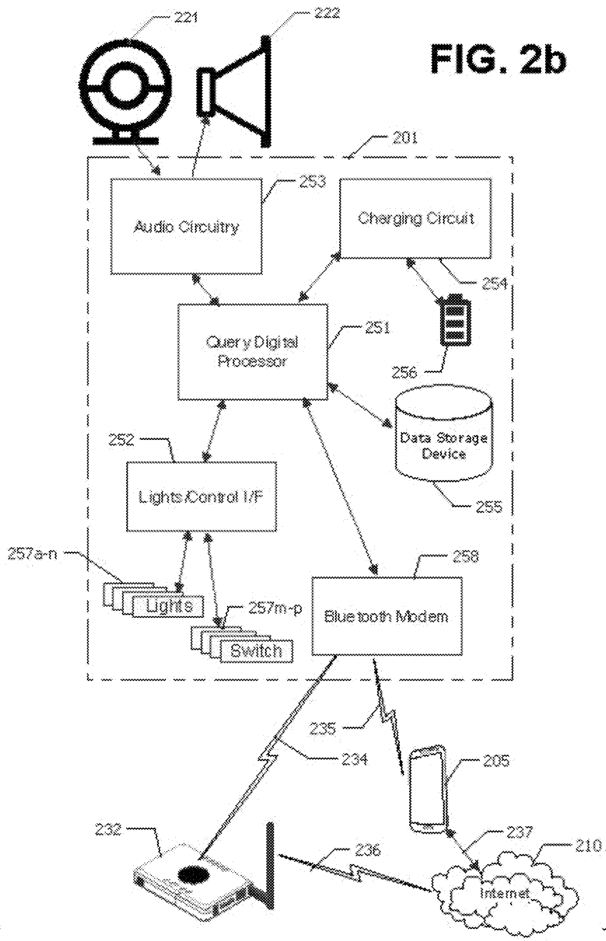

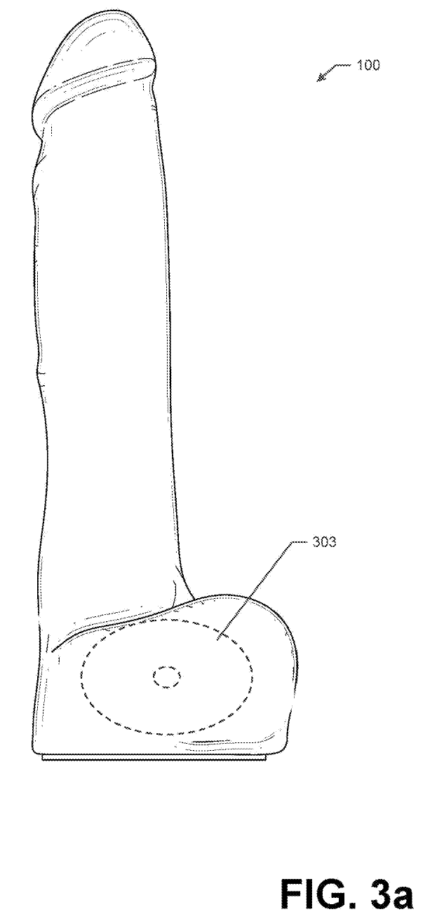

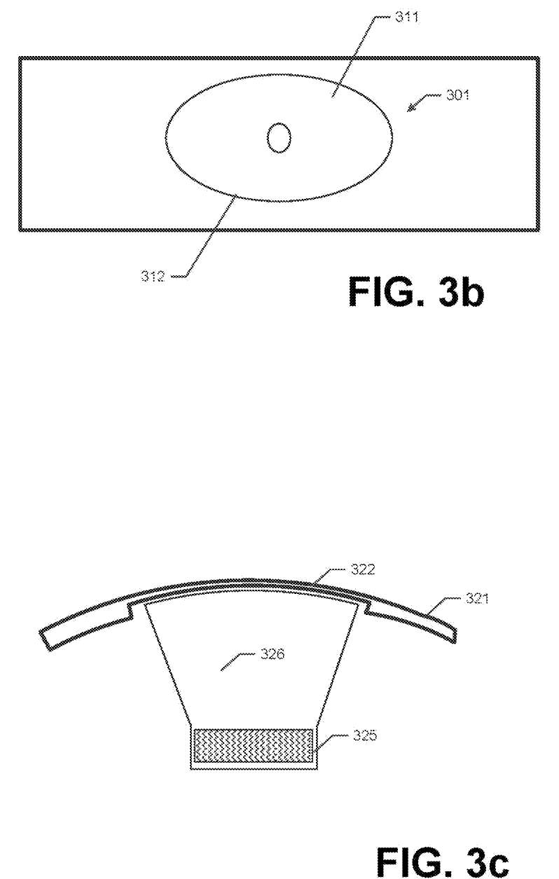

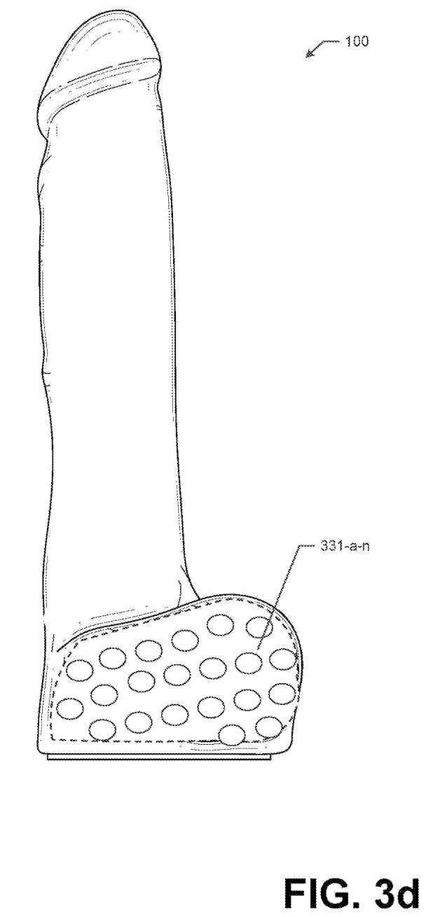

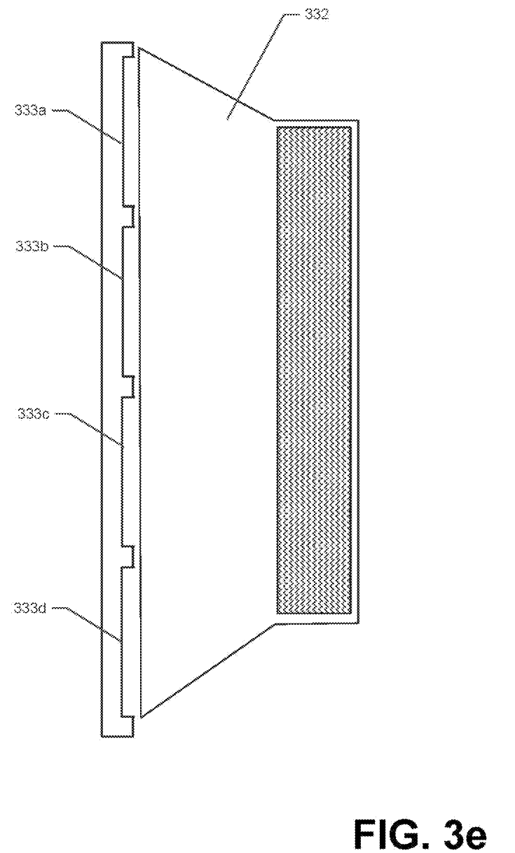

The audio internal speaker elements 104 within the wireless-enabled sex toy 100 generate sound capable of being heard by partners 261-262 using the wireless-enabled sex toy 100. The audio internal speaker elements 222 as disclosed in reference to FIGS. 2-3 below are coupled to an outer surface of the sex toy elongated body 101 permitting generated sound to be heard outside of the wireless-enabled sex toy 100. By this arrangement, the inner cavity of the wireless-enabled sex toy elongated body 101 may been enclosed by the outer surface of the wireless-enabled sex toy 100 making it less susceptible to moisture from bodily fluids when in use. The inner cavity of the wireless-enabled sex toy elongated body 101 may be separated into two adjacent compartments separated by an internal surface. The audio internal speaker elements 222 may be placed within a bottom compartment at a bottom end of the wireless-enabled sex toy 100. The electronic controller circuitry 202 may be placed within a larger upper compartment. A wire connecting the audio internal speaker elements 222 and the electronic controller circuitry 202 may pass through the internal surface and be sealed within through hole in the internal surface.

The wireless-enabled sex toy 100 uses the electronic controller circuitry 202 shown in FIGS. 2a-b, included within the wireless-enabled sex toy elongated body 101, to generate the audio output. For example, in one embodiment of wireless-enabled sex toy 100 generates music and similar sounds from signals received from an external device 205 as disclosed in reference to FIGS. 2a-b herein. In another embodiment, sounds from a Voice-over-IP connection with the external device 205 may be generated enabling communications between partners 261-262 when the wireless-enabled sex toy 100 is used while the partners 261-262 are apart from each other.

FIGS. 2a-b illustrates additional example embodiments of an article of manufacture providing a wireless-enabled sex toy according to the present invention. FIG. 2a shows an AI-based wireless-enabled sex toy 201 having an electronic controller circuitry 202, a speaker 222, a local data storage 223, a transmitter-receiver 224, a vibration generator 226, and a heating element 225. One or more partners 261-262 utilize the wireless-enabled sex toy 100 by receiving digital auditory data to generate sound outputted by the electronic controller circuitry 202.

The electronic controller circuitry 202 processes all received auditory data and generates the audio provided to the partners 261-262. The components within the electronic controller circuitry 202 include hardware components disclosed in reference to FIG. 2b.

The speaker 222 generates auditory signals passing through the audio output screen 131 in the wireless-enabled sex toy removable bottom surface 103 as shown in FIGS. 3a-f. The partners 261-262 can hear these auditory signals while utilizing the wireless-enabled sex toy 100.

The local data storage 223 provides data storage for use in processing commands and generating responses within the electronic controller circuitry 202. The wireless network modem 223 may store auditory data and sound effects supported by the electronic controller circuitry 202. The wireless network modem 223 also may store data associated with the operation of other components within the wireless-enabled sex toy 100 including the transmitter-receiver 224, the vibration generator 226, and the heating element 225.

The heating element 225 may be included within the electronic controller circuitry 202 and the wireless-enabled sex toy elongated body 101. The heating element 225 generates heat to warm the outer surface of the wireless-enabled sex toy elongated body 101 making use of the wireless-enabled sex toy 100 more pleasurable. The heating element 225 may be controlled by the processor in the electronic controller circuitry 202 in response to voice commands and/or heating commands from the mobile communications device 205 and other computing devices. The heating element 225 also may be controlled using input buttons or switches located on the wireless-enabled sex toy elongated body 101 and/or wireless-enabled sex toy removable bottom cover 102 that directly enable the heating element 225 to operate.

The vibration generator 226 may be included within the electronic controller circuitry 202 and the wireless-enabled sex toy elongated body 101. The vibration generator 226 generates vibrations within the wireless-enabled sex toy elongated body 101 to simulate the movement of the outer surface of the wireless-enabled sex toy elongated body 101 making use of the wireless-enabled sex toy 100 more pleasurable. The vibration generator 226 may be controlled by the processor in the electronic controller circuitry 202 in response to voice commands and/or heating commands from the mobile computing device 205 and other computing devices. The vibration generator 226 also may be controlled using input buttons or switches located on the wireless-enabled sex toy elongated body 101 and/or wireless-enabled sex toy removable bottom cover 102 that directly enable the vibration generator 226 to operate.

FIG. 2b shows a set of electronic components included within the electronic controller circuitry 202 including a programmable internal controller 251, a Bluetooth^{TH} modem 252, audio circuitry 253, charging circuitry 254, a rechargeable battery 256, and a data storage device 255. The programmable internal controller 251 receives and processes an input signal from input-output interface. The programmable internal controller 251 may generate a response to these inputs. The programmable internal controller 251 may control the operation of the vibration generator and heating elements using the vibration generator 226 and the heating element heating element 225.

The Bluetooth^{TM} modem 252 sends and receives electromagnetic signals to create a digital communications channel between the electronic controller circuitry 202 and the network access point 232. The Bluetooth^{TM} modem 252 receives digital data from the programmable internal controller 251 that is to be communicated to a remote device, such as the mobile computing device 205 and remote server 203 using a protocol. The Bluetooth^{TM} modem 252 also may utilize other wireless communication channels and protocols consistent with the utilization disclosed herein.

The audio circuitry 253 connects speaker 222 to the electronic controller circuitry 202 and its components while converting the auditory signals to and from digital data representations.

The charging circuitry 254 receives input electrical voltage from the charging port 132 to charge the rechargeable battery 256. The charging circuitry 254 connects the input electrical voltage to the rechargeable battery 256 for recharging. The charging circuitry 254 also monitors the voltage within the rechargeable battery 256 while in use and also when recharging to provide an indication of the amount of electrical charge within the rechargeable battery 256. The charging circuitry 254 also may disconnect the input electrical voltage from the rechargeable battery 256 when the rechargeable battery 256 has been recharged to a maximum storage level and prolong the usable life of the rechargeable battery 256.

The rechargeable battery 256 is an electrical charge storage device used to provide power to the electronic controller circuitry 202 and all electrically powered components within the AI-based wireless-enabled sex toy 201.

The data storage device 255 is a digital data storage device such as a disk drive, solid-state storage device, and similar electrical devices. The data storage device 255 stores the digital data 215 used to operate the digital hardware and software components in the wireless-enabled sex toy 100.

For example, one embodiment, the electronic controller circuitry 202 may respond to commands to control the speaker 222, the heating element 225, the vibration generator 226, and the Bluetooth^{TH} modem 252.

In yet another embodiment, the electronic controller circuitry 202 generates synthetic human speech data corresponding to the responsive results generated by the wireless-enabled sex toy 100. The voice generation may translate the response into one or more languages corresponding to the preferences of the partners 261-262. One or more of the partners 261-262 also may provide commands to the electronic controller circuitry 202 that instructs a specific one or more languages to be used in providing the responsive data.

Additionally, the voice generated by the electronic controller circuitry 202 also may correspond to a synthesized representation of the voice of one of the partners 261-262. One or more of the partners 261-262 may provide sample voice data to the electronic controller circuitry 202 that is used to generate the synthesized voice data. The synthesized representation of the voice enables one of the partners 261-262 to interact with the synthesized voice of the other partner during times when the partner is not present and unavailable to participate in the activity.

In an alternate embodiment, the wireless-enabled sex toy 100 may communicate with remote individuals using a voice call, a Voice-over-IP (VoIP) connection, or a similar video/audio call to permit the partners 261-262 to interact with each other while one of the partners uses the wireless-enabled sex toy 100. The wireless-enabled sex toy 100 may connect to a mobile computing device 205 as disclosed herein in reference to FIGS. 2a-b below. The mobile computing device 205 may be used to connect the partners 261-262 to each other using a voice and/or video call while their respective voices may provide input and commands to the electronic controller circuitry 202 as otherwise disclosed herein. Similarly, the electronic controller circuitry 202 may include an application that provides a VoIP connection to a remote computing device such as a mobile phone, tablet, or computer. Once the connection is established, the partners 261-262 may interact with the wireless-enabled sex toy 100 as disclosed herein.

In other embodiments, the electronic controller circuitry 202 may output music, sound effects, and similar auditory sounds to enhance the mood of the partners 261-262 while they interact with each other and use the wireless-enabled sex toy 100. The music output by the electronic controller circuitry 202 may include digitally encoded music stored within the electronic controller circuitry 202. Alternatively, the electronic controller circuitry 202 may connect to remote computing devices to request and receive streaming data from remote services and data sources.

The electronic controller circuitry 202 also may generate sound effects requested by one of the partners 261-262 using voice commands. For example, one of the partners may request the generation of barking like an animal while the wireless-enabled sex toy 100 is in use. The electronic controller circuitry 202 may retrieve and generate auditory data corresponding to the animal that is output to the users.

FIGS. 3a-f illustrate a plurality of speaker placement arrangements for providing a sex toy having an integrated speaker coupled to the surface of the device according to the present invention. FIG. 3a shows the wireless-enabled sex toy 100 having one or more speaker elements 301-303 coupled to the wireless-enabled sex toy 100 at on the surface of the bottom compartment of the wireless-enabled sex toy 100. These one or more speaker elements 301-303 may be positioned along any portion of the outer surface of bottom compartment of the wireless-enabled sex toy 100.

These one or more speaker elements 301-303 also may each have different sizes and arrangements within the wireless-enabled sex toy 100. Each of the one or more speaker elements 301-303 are coupled to the inner surface of inner compartment as shown in FIGS. 3b-f such that the sound generated by the speaker elements 301-303 penetrates the outer material of the wireless-enabled sex toy 100 to be heard by partners 261-262 using the wireless-enabled sex toy 100. The sound generated by the one or more speaker elements 301-303 allows the partners 261-262 to hear music, sound effects, and synthesized voices received by the wireless-enabled sex toy 100 from an external data source such as a smartphone 205.

FIG. 3b shows a speaker element 311 that is one of the one or more speaker elements 301-303 disclosed in reference to FIG. 3a. The speaker element 311 is coupled to the outer surface 321 of the bottom compartment as shown in FIG. 3c. The speaker element 311 is coupled about the outer edge 312 of the speaker element 301 with sound generated therein affecting a thinner outer surface 322 within the speaker element 311 causing it to vibrate corresponding to the sound waves generated by the speaker element 311. The vibrating thinner outer surface 322 causes the sound wave to be generated allowing the sounds to be heard by the partner 261-262 using the wireless-enabled sex toy 100.

FIG. 3c also shows a lower portion 325 of the speaker element 311 including in an example embodiment as having a speaker cone 326 and a magnet element of the speaker element 311. The lower portion 325 of the speaker element 311 may correspond to any similar sound generating device in which sound waves may be generated in response to an analog auditory signal.

FIG. 3d shows an alternate arrangement of a plurality of speaker elements 331a-n positions about sides of a lower end of the wireless-enabled sex toy 100 in the bottom compartment. In this embodiment, the speaker element 332 is positioned under a plurality of thinner outer surfaces 333a-d as shown in FIG. 3e. The sound generated by the speaker element 332 simultaneously affects all of the plurality of thinner outer surfaces 333a-d as the sound is generated outside of the wireless-enabled sex toy 100. Each of these thinner outer surfaces 333a-d may vibrate in response to sound waves from the speaker element 332 in a similar manner as described above in reference to FIG. 3c.

FIG. 3e shows the speaker element 332 interacting with a number of thinner outer surfaces 333a-d in which any number of thinner outer surfaces 333a-d may be located within the outer edge 312 of the speaker element 332 depending upon the size of the outer edge 312 and the speaker element 332.

FIG. 3f shows speaker elements 332 within a bottom surface 311 in a manner similar to FIG. 3f. The shape of the speaker elements 332, shown as parallel openings in FIG. 3f may be arranged in many different patterns in which the speaker element 332 couples to the bottom surface 311 as shown in FIG. 3e.

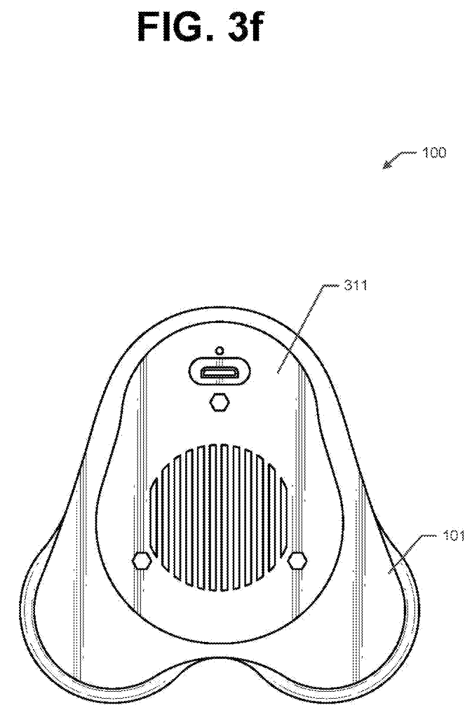

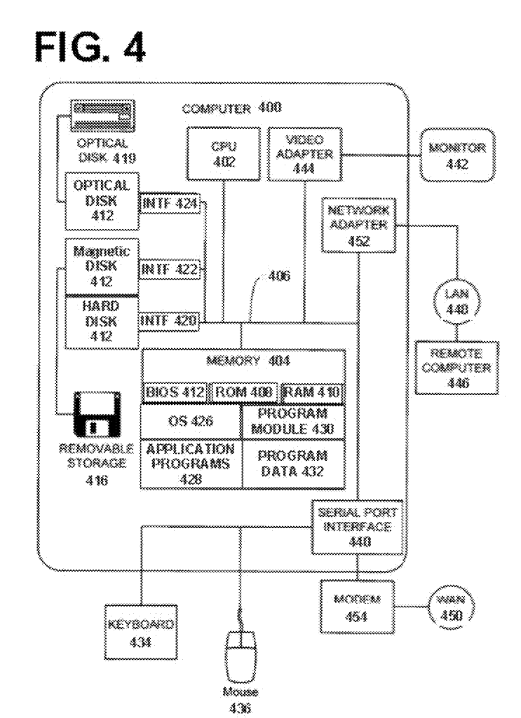

FIG. 4 illustrates a generalized schematic of a programmable processing system utilized as the various computing components described herein used to implement an embodiment of the present invention. The electronic controller circuitry 202 and internal controller 251 may be implemented as a digital processing system 400 that contains software in the form of executable instructions stored within the memory of the 202. When the CPU 402 executes these instructions in memory causing the wireless-enabled sex toy 101 to perform the functions of the system 100 as described herein. The digital processing system 400 may also correspond to digital computing devices including wireless network modem 223, mobile computing device 205, and remote server 203.

The CPU 402 is coupled to the system bus 404. The CPU 402 may be a general-purpose CPU or microprocessor, graphics processing unit (“GPU”), and/or microcontroller. The present embodiments are not restricted by the architecture of the CPU 402 so long as the CPU 402, whether directly or indirectly, supports the operations as described herein. The CPU 402 may execute the various logical instructions according to the present embodiments.

The computer system 400 also may include random access memory (RAM) 408, which may be synchronous RAM (SRAM), dynamic RAM (DRAM), synchronous dynamic RAM (SDRAM), or the like. The computer system 400 may utilize RAM 408 to store the various data structures used by a software application. The computer system 400 may also include read-only memory (ROM) 406 which may be PROM, EPROM, EEPROM, optical storage, or the like. The ROM may store configuration information for booting the computer system 400. The RAM 408 and the ROM 406 hold user and system data, and both the RAM 408 and the ROM 406 may be randomly accessed.

The computer system 400 may also include an input/output (I/O) adapter 410, a communications adapter 414, a user interface adapter 416, and a display adapter 422. The I/O adapter 410 and/or the user interface adapter 416 may, in certain embodiments, enable a user to interact with the computer system 400. In a further embodiment, the display adapter 422 may display a graphical user interface (GUI) associated with a software or web-based application on a display device 424, such as a monitor or touch screen.

The I/O adapter 410 may couple one or more storage devices 412, such as one or more of a hard drive, a solid-state storage device, a flash drive, a compact disc (CD) drive, a floppy disk drive, and a tape drive, to the computer system 400. According to one embodiment, the data storage 412 may be a separate server coupled to the computer system 400 through a network connection to the I/O adapter 410. The communications adapter 414 may be adapted to couple the computer system 400 to the network 408, which may be one or more of a LAN, WAN, and/or the Internet. The communications adapter 414 may also be adapted to couple the computer system 400 to other networks such as a global positioning system (GPS) or a Bluetooth network. The user interface adapter 416 couples user input devices, such as a keyboard 420, a pointing device 418, and/or a touch screen (not shown) to the computer system 400. The keyboard 420 may be an on-screen keyboard displayed on a touch panel. Additional devices (not shown) such as a camera, microphone, video camera, accelerometer, compass, and or gyroscope may be coupled to the user interface adapter 416. The display adapter 422 may be driven by the CPU 402 to control the display on the display device 424. Any of the devices 402-422 may be physical and/or logical.

The applications of the present disclosure are not limited to the architecture of computer system 400. Rather the computer system 400 is provided as an example of one type of computing device that may be adapted to perform the functions of a wireless-enabled sex toy 100, including servers, personal computers, and mobile devices as shown in FIGS. 2a-c. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large-scale integrated (VLSI) circuits, or other circuitry. In fact, persons of ordinary skill in the art may utilize any number of suitable structures capable of executing logical operations according to the described embodiments. For example, the programmable internal controller 251, remote server 203, and mobile computing device 205 may be virtualized for access by multiple users and/or applications.

Additionally, the embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure and covers all changes and modifications that do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

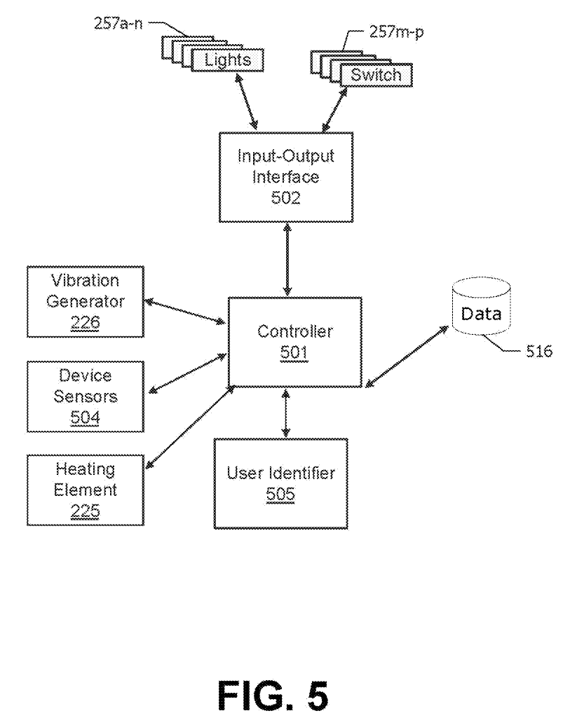

FIG. 5 illustrates a set of software components executable in a programable computing device implementing a wireless-enabled sex toy 100 according to the present invention. The set of software components 500 include a controller 501, an input-output interface 502, a voice personalization processor 503, device sensors 504, user identifier 505, a user preference and history processor 506, a vibration generation controller 526, and a heating element controller 525.

The query controller 501 receives and processes a user input signal from input-output interface. The query controller 501 may also receive input signals from the device sensors 504. The query controller 501 may communicate with the user preference and history processor 506 to generate a response. The query controller 501 may control the operation of the vibration generator and heating elements using the vibration generation controller 526 and the heating element controller 525.

The input-output interface 502 provides input and output processing to provide a query processor 501 input commands and associated data needed to response generation as needed. The input-output interface 502 also formats and generates auditory output associated with the generated response to be sent to users and partners.

The voice personalization processor 503 receives the generated response and generates a synthetic voice representation of the generated response in a selected representative voice. The selected representative voice may correspond to a default voice in either gender or a representation of a particular individual voice trained and saved for use by particular users. The voice personalization processor 503 may use the user preference and history processor 506 to select the selected representative voice.

The device sensors 504 receives sensor input signals and formats them into a corresponding digital data format useful to perform processing by various software components 501-503 and 526-526.

The user identifier 505 processes auditory input data to identify a user and partners currently using the wireless-enabled sex toy 100 to obtain user preference and history data for use by various software components 501-504 and 511-517 when performing the corresponding functions in processing input commands and data to generate a response.

The user preference and history processor 506 maintains user preference data associated with user who have previously used the wireless-enabled sex toy 100. The user preference data corresponds to control parameters to generate a response corresponding to the preferences of the particular user. The user preference and history processor 506 may also update the user preference data based upon activities and inputs detected during use of the wireless-enabled sex toy 100 by a particular user.

The vibration generation controller 526 controls the operation of the vibration generator 226 to provide an operating state about detectable vibration within the wireless-enabled sex toy elongated body 101 when in use. The vibration generation controller 526 may receive signal data from the device sensors 504 to determine the operating state of the wireless-enabled sex toy elongated body 101 as compared to a selected vibration setting.

The heating element controller 525 controls the operation of the heating element 225 to provide a selected temperature about the wireless-enabled sex toy elongated body 101 when in use. The heating element controller 525 may receive signal data from the device sensors 504 to determine a current temperature to be compared with a selected temperature.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing a wireless-enabled sex toy having an internal cavity divided into a upper compartment and a bottom compartment, the system comprising:
a sexual stimulation device having a sex toy elongated body, an inner cavity, and an outer surface between the inner cavity and outside of the sex toy elongated body, the inner cavity encloses:
a wireless transmitter-receiver;
a heating element;
a vibration generator;
a microphone;
a speaker, the speaker having an outer edge and a speaker element, wherein one or more thinner outer surfaces; and
an electronic controller circuitry, the electronic controller circuity comprises:
an audio circuitry;
a charging circuit;
a rechargeable battery;
a wireless modem;
a data storage device; and
a controller.

2. The system according to claim 1, wherein the controller controls the operation of the heating element and the vibration generator.

3. The system according to claim 1, wherein the controller receives user input signal from the audio circuitry and generates an auditory response by the audio circuitry.

4. The system according to claim 1, wherein the auditory response includes one or more of the following auditory data type: a streaming music recording, sound effects, auditory sounds to enhance the mood, synthetic human speech data, and Voice-over-IP (VoIP) connection data.

5. The system according to claim 4, wherein the controller receives auditory data content from a remote content server, the auditory data content includes one or more of the following: the streaming music recording, the sound effects, and the auditory sounds to enhance the mood.

6. The system according to claim 5, wherein the controller communicates with remote servers utilizing a mobile communications device.

7. The system according to claim 1, wherein the electronic controller circuity is contained within an upper compartment of the internal cavity.

8. The system according to claim 2, wherein the speaker is contained within an bottom compartment of the internal cavity.
